(19) United States
(12) Patent Application Publication
(10) Pub. No.: US 2006/0106953 A1
(43) Pub. Date: May 18, 2006

(54) Portable disk-based information device

(75) Inventors: Declan P. Kelly, Eindhoven (NL); Jozef P. Van Gassel, Sevenum (NL); Wilhelmus F.J. Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/540,184

(22) PCT Filed: Dec. 5, 2003
(86) PCT No.: PCT/IB03/05818

§ 371 Date: Jun. 20, 2005

(51) Int. Cl. G06F 3/00

(52) U.S. Cl. 710/13

(57) ABSTRACT

The invention provides a method and system for obtaining updated information using a portable disk-based information device. The disk-based information device may be included within or attached to a portable networking device such as a personal data assistant (PDA) or a cellular telephone. Update information may be received from a data provider through, for example, a mobile telephone network. The update information may be compared with information provided on the disk. Updated information may then be delivered to a user in response to a user request, reporting new information and replacing outdated information provided on the disk with information received from the data provider.

This invention relates generally to wireless data transmission. More specifically, the invention relates to a method and system for obtaining updated information using a portable disk-based information device.

A wide range of navigation and point of interest (POI) systems is currently available. These systems offer not only routing information to specific destinations, but also assistance in locating gas stations, hotels, restaurants, and other businesses or services. Such systems may be factory-installed motor vehicle systems, independent portable devices, or even software packages for use with a personal data assistant (PDA).

Navigation and POI systems are typically either disc-based or interactive. In a disc-based system, the maps and other data required by a navigation system or other information device are generally provided on optical disks. Such disks are able to store large quantities of information and are inexpensive to manufacture and distribute. Unfortunately, any information provided on a disk is entirely static and will, eventually, become out of date. New disks may be manufactured and distributed when roads are added, businesses relocate, or other data on a disk change. However, new versions of the disks may not be available as often as would be desirable, and even frequently updated disks cannot provide transient information such as road closures due to major motor vehicle accidents or special discounts being offered by a restaurant that might make that restaurant more appealing to a user than another, equally close restaurant.

Interactive systems are often installed in motor vehicles and provide the desired information through a wireless communication system. These systems are typically server based and are able to provide the transient information that is not available using a disc-based system. However, if for any reason the system loses its connection with the server, no information will be available to the user, not even the potentially outdated information that is provided by a disc-based system. Also, an interactive system is often permanently affixed to a vehicle, so the user cannot obtain information when away from the vehicle.

It would be desirable, therefore, to provide a method and system for obtaining updated information using a portable disk-based information device that overcomes the aforementioned and other disadvantages.

One aspect of the invention provides a method for obtaining updated information using a portable disk-based information device. Update information is requested and received from a data provider. The update information is compared with information provided on the disk. Updated information is then delivered to a user in response to a user request, reporting new information and replacing outdated information provided on the disk with information received from the data provider.

Another aspect of the invention provides a method for obtaining updated information using a disk-based information device. Update information is broadcast by and received from a data provider. The update information is compared with information provided on the disk. Updated information is then delivered to a user in response to a user request, reporting new information and replacing outdated information provided on the disk with information received from the data provider.

Yet another aspect of the invention provides a computer-usable medium including a program for obtaining updated information using a portable disk-based information device. The program includes computer program code for requesting update information from a data provider, receiving the update information from the data provider, comparing the update information with information provided on the disk, and delivering updated information to a user in response to a user request, reporting new information and replacing outdated information provided on the disk with information received from the data provider.

Still another aspect of the invention provides a system for obtaining updated information using a portable disk-based information device. The system includes means for requesting update information from a data provider, for receiving the update information from the data provider, for comparing the update information with information provided on the disk, and for delivering updated information to a user in response to a user request, reporting new information and replacing outdated information provided on the disk with information received from the data provider.

The aforementioned, and other features and advantages of the invention, will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

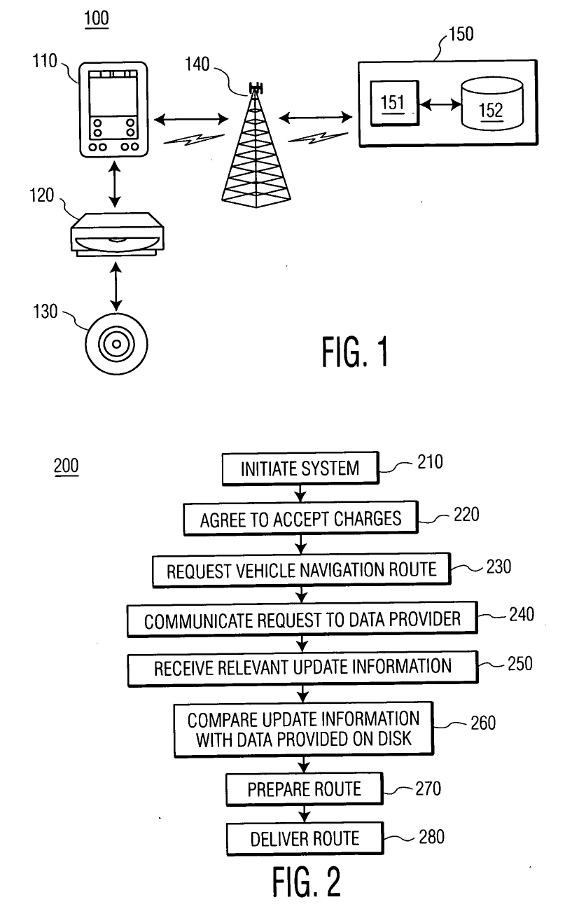

FIG. 1 is an illustration of one embodiment of a system for obtaining updated information using a portable disk-based information device, in accordance with the current invention;

FIG. 2 is a flow diagram of one embodiment of a method for obtaining updated information using a portable disk-based information device in an example system according to FIG. 1;

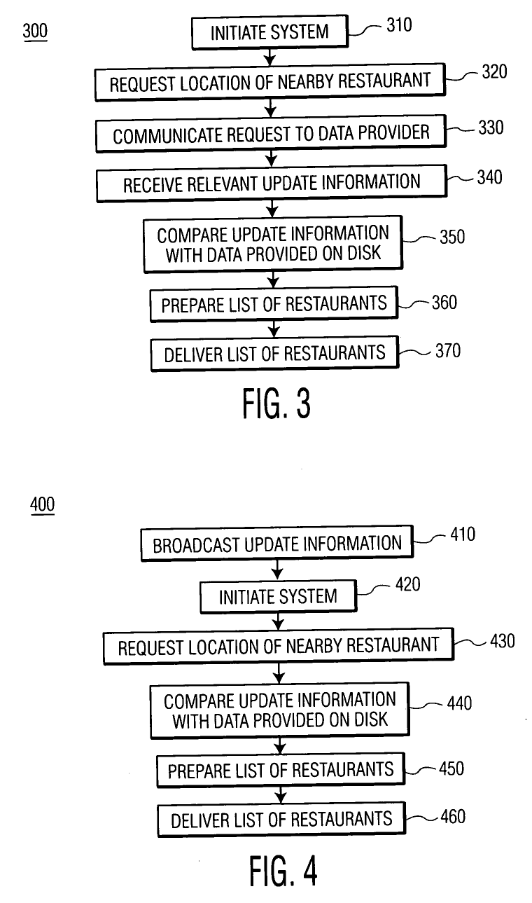

FIG. 3 is a flow diagram of another embodiment of a method for obtaining updated information using a portable disk-based information device in an example system according to FIG. 1; and

FIG. 4 is a flow diagram of another embodiment of a method for obtaining updated information using a portable disk-based information device in an example system according to FIG. 1.

FIG. 1 shows an illustration of one embodiment of a system for obtaining updated information using a portable disk-based information device, in accordance with the present invention at 100.

System 100 may contain one or more portable networking devices 110, one or more disk drives 120, one or more disks 130, one or more wireless communication networks 140, and one or more data providers 150. Data provider 150 may include one or more data transceivers 151 and one or more databases 152.

Portable networking device 110 may be, for example, a personal data assistant (PDA), a cellular telephone, or any other appropriate device. Portable networking device 110 may be connected to disk drive 120. Disk drive 120 may be contained within networking device 110 or may be a separate, peripheral device. Disk drive 120 may be, for example, a miniature optical disc drive that uses blue-laser technology

Disk drive 120 may run program or data disks 130. Both programming and data storage functions may be included on the same disk. The disk may be, for example, a read-only small form factor optical disk. The disk may contain programming and data for a navigation system, a city guide, a hotel guide, a public transportation schedule, a business directory, or any appropriate information service.

Portable networking device 110 may contain or be connected with a system capable of determining a geophysical location of the device. The system may be a global positioning system (GPS), a GPS-like system operated by a foreign country or other entity, or a system employing a location technology such as time difference of arrival (TDOA), angle of arrival (AOA), or cell of origin (COO).

The GPS or other unit may be the source of positional information that is used to identify businesses, events, or other points of interest within a limited geographic area relative to the device and its user. The positional information may also be used to minimize the amount of update information that is transferred by limiting it to only that which is relevant to the current location of the user. The amount of information transferred may additionally be limited by the user's search criteria. For example, a request for a restaurant in a specified location would prompt the transfer of updates for that location only, or a request for a driving route from point A to point B would prompt the transfer of updates for only those roads included in the delivered route. In another example, the positional information may be used to determine what information is broadcast.

Portable networking device 110 may contain or be connected with software and hardware for storing some or all update information received from the data provider 150, using, for example, memory caching, disk caching, non-volatile random access memory (NVRAM), magnetoresistive random access memory (MRAM), or a mixed-function disk that is capable of storing read-only information and recording update information. Alternatively, the updated information may remain transient within the portable networking device 110 or a peripheral.

Portable networking device 110 may contain or be connected with software and hardware to allow a user of the device to agree to accept charges associated with receiving update information from a data provider 150. Such charges may be, for example, charges assessed by wireless communication network 140 for transmitting the update information or charges assessed by data provider 150 for providing the update information.

Portable networking device 110 may contain or be connected with software and hardware for comparing the update information received from the data provider 150 with information provided on the disk 130. Portable networking device 110 may also contain or be connected with software and hardware for delivering updated information to a user in response to a user request, reporting new information and replacing outdated information provided on the disk with information received from the data provider 150.

Portable networking device 110 may contain or be connected with a wireless transceiver capable of communicating with a data provider 150 using a wireless communication network 140. Portable networking device 110 may also contain or be connected with software and additional hardware to enable communications with the data provider 150. The software and hardware may, for example, enable portable networking device 110 to request and receive update information from the data provider 150 through wireless communication network 140. Communications between portable networking device 110 and data provider 150 may also include information regarding the user's search criteria, the geophysical location of the disk-based information device, identifiers for the user of the disk-based information device, identifiers for the application or disk being used, and other suitable information regarding the system 100 and its user.

Wireless communication network 140 may be operably connected with portable networking device 110 and with data provider 150. Wireless communication network 140 may be, for example, a mobile telephone network, a local-area network, or a satellite network.

Data provider 150 may include one or more data transceivers 151 and one or more databases 152. Data transceiver 151 may be capable of receiving data from and transmitting data to portable networking device 110 through wireless communication network 140. Data transceiver 151 may be, for example, an IP router or a modem. Database 152 may contain updated information related to, for example, road work, road closures, major motor vehicle accidents, price and availability of hotel rooms, operating hours of tourist attractions, local advertising, special promotions, and telephone directories.

FIG. 2 shows a flow diagram of one embodiment of a method for obtaining updated information using a portable disk-based information device, in accordance with the current invention at 200. Method 200 comprises steps to request update information from a data provider, receive the update information from the data provider, compare the update information with information provided on the disk, and deliver updated information to a user in response to a user request, reporting new information and replacing outdated information provided on the disk with information received from the data provider.

The user may first initiate the system shown in FIG. 1 (Block 210). In the case of a motor vehicle navigation system, for example, the user may be willing to pay for the convenience of having the most up-to-date information. Therefore, the user may agree to accept charges associated with receiving the update information (Block 220). Such charges may include those assessed by the data provider 150 for providing the update information or those assessed by the wireless communication network 140 for transmitting the update information. The user may agree to accept charges by taking actions such as placing the program disk in the disk drive, starting the application, keying in a password, responding to an application prompt, or by agreeing in advance to a set monthly fee for receiving the updates.

The user may request information such as a motor vehicle navigation route from point A to point B (Block 230). This may be accomplished using a portable networking device 110 by, for example, speaking the request into a cellular telephone or keying the request into a personal data assistant (PDA).

The request may be communicated from the portable networking device 110 to a data provider 150 through a wireless communication network 140 (Block 240). The request may include information regarding the user's search criteria, the geophysical location of the disk-based information device, identifiers for the user of the device, identifiers for the version of the application or disk being used, or other information regarding the system and its user.

This information may be used to minimize the amount of update information transmitted. For example, the user's search criteria or the geophysical location of the device may be used to limit update information to that relevant to a specific geographic area. Identifying the disk version may allow the data provider to limit update information to that occurring after a particular disk version was released.

In response to the request, relevant update information may be transmitted by the data provider and received by the system (Block 250). The update information may remain transient; or some or all of the information may be stored using, for example, memory caching, disk caching, non-volatile random access memory (NVRAM), magnetoresistive random access memory (MRAM), or a mixed-function disk that is capable of storing read-only information and recording update information. Relatively permanent information such as new roads or new addresses may be saved to the disk, for example.

The update information may be compared with the information provided on the disk (Block 260). The system may then prepare a recommended motor vehicle route from point A to point B (Block 270), reporting any new information received from the data provider and replacing outdated information provided on the disk with updated information received from the data provider.

When the route is delivered to the user (Block 280), the user may be unaware which information has been provided on the disk and which information has been received from the data provider, except perhaps, when real-time traffic information is provided.

FIG. 3 is a flow diagram of one embodiment of a method for obtaining updated information using a disk-based information device, in accordance with the current invention at 300. Method 300 comprises steps to request update information from a data provider, receive the update information from the data provider, compare the update information with information provided on the disk, and deliver updated information to a user in response to a user request, reporting new information and replacing outdated information provided on the disk with information received from the data provider.

The user may first initiate the system shown in FIG. 1 (Block 310). In the case of a city guide or business directory, for example, the disk and the associated update information may be provided to the user free of charge. Therefore, there may be no need for the user to agree to charges associated with receiving the update information. The cost of the disk and update information may be offset by advertising or fees paid by merchants and others featured in the city guide or business directory.

The user may request information such as the location of a nearby restaurant (Block 320). This may be accomplished using a portable networking device 110 by, for example, speaking the request into a cellular telephone or keying the request into a personal data assistant (PDA).

The request may be communicated from the portable networking device 110 to a data provider 150 through a wireless communication network 140 (Block 330). The request may include information regarding the user's search criteria, the geophysical location of the disk-based information device, identifiers for the user of the device, identifiers for the version of the application or disk being used, or other information regarding the system 100 and its user.

This information may be used to minimize the amount of update information transmitted. For example, the user's search criteria or the geophysical location of the device may be used to limit update information to that relevant to a specific geographic area. Identifying the disk version may allow the data provider to limit update information to that occurring after a particular disk version was released.

In response to the request, relevant update information may be transmitted by the data provider and received by the system (Block 340). In the case of a service offered free of charge, update information may be provided not only in response to a specific request, but also spontaneously as considered appropriate by those offering the service. The update information may remain transient; or some or all of the information may be stored using, for example, memory caching, disk caching, non-volatile random access memory (NVRAM), magnetoresistive random access memory (MRAM), or a mixed-function disk that is capable of storing read-only information and recording update information. Relatively permanent information such as new roads or new addresses may be saved to the disk, for example.

The update information may be compared with the information provided on the disk (Block 350). The system may then prepare a list of restaurants meeting the request criteria (Block 360), reporting any new information received from the data provider and replacing outdated information provided on the disk with updated information received from the data provider.

When the list is delivered to the user (Block 370), it may be transparent to the user which information was originally contained on the disk and which information was received from the data provider. In addition to the requested information, the system may also deliver coupons, advertisements, information regarding special discounts, or other similar information.

FIG. 4 shows a flow diagram of one embodiment of a method for obtaining updated information using a disk-based information device, in accordance with the current invention at 400. Method 400 comprises steps to broadcast update information from a data provider, receive the update information from the data provider, compare the update information with information provided on the disk, and deliver updated information to a user in response to a user request, reporting new information and replacing outdated information provided on the disk with information received from the data provider.

Information may be broadcast by the data provider 150 through a wireless communication network 140 to a disk-based information system that is contained within or attached as a separate, peripheral device to a networking device 110. (Block 410). The update information may be broadcast simultaneously to multiple disk-based information devices rather than over a dedicated connection.

In the case of a city guide or business directory, for example, the disk and the broadcast update information may be provided to the user free of charge. The cost of the disk and update information may be offset by advertising or fees paid by merchants and others featured in the city guide or business directory. Alternatively, a user may agree in advance to a set monthly fee for receiving update broadcasts.

The update information may remain transient; or some or all of the information may be stored using, for example, memory caching, disk caching, non-volatile random access memory (NVRAM), magnetoresistive random access memory (MRAM), or a mixed-function disk that is capable of storing read-only information and recording update information. Relatively permanent information such as new roads or new addresses may be saved to the disk, for example.

The broadcast update information may already have been received when the user initiates the system shown in FIG. 1 (Block 420). The user may request information such as the location of a nearby restaurant (Block 430). This may be accomplished using a portable networking device 110 by, for example, speaking the request into a cellular telephone or keying the request into a personal data assistant (PDA).

In response to the request, the system may compare the update information with the information provided on the disk (Block 440). It may then prepare a list of restaurants meeting the request criteria (Block 450), reporting any new information broadcast by and received from the data provider and replacing outdated information provided on the disk with updated information broadcast by and received from the data provider.

When the list is delivered to the user (Block 460), it may be transparent to the user which information was originally contained on the disk and which information was received from the data provider. In addition to the requested information, the system may also deliver coupons, advertisements, information regarding special discounts, or other similar information.

In practice, the current invention allows large quantities of information to be provided using an inexpensive means such as a read-only disk. Updates to the information may then be provided using a more expensive means such as a mobile telephone network. When combined, the two provide a relatively inexpensive means of obtaining information that is always up to date.

While the embodiments of the invention disclosed herein are presently considered to be preferred, various changes and modifications can be made without departing from the spirit and scope of the invention. The scope of the invention is indicated in the appended claims, and all changes and modifications that come within the meaning and range of equivalents are intended to be embraced therein.

1. A method for receiving updated information using a portable disk-based information device, comprising:
requesting update information from a data provider 150;
receiving the update information from the data provider 150;
comparing the update information with information provided on the disk; and
delivering updated information to a user in response to a user request, reporting new information and replacing outdated information provided on the disk with information received from the data provider 150.

2. The method of claim 1 further comprising;
first agreeing to accept charges associated with receiving update information from a data provider 150.

3. The method of claim 1 wherein the disk-based information device is one of a navigation device, a city guide, a hotel guide, a transportation schedule, or a business directory.

4. The method of claim 1 wherein the disk-based information device is operably connected to a portable networking device 110.

5. The method of claim 4 wherein the portable networking device 110 is one of a personal data assistant (PDA) or a cellular telephone.

6. The method of claim 1 wherein the data provider 150 is accessed through a wireless communication network.

7. The method of claim 4 wherein the wireless communication network is one of a mobile telephone network, a local-area network, or a satellite network.

8. The method of claim 1 wherein the disk-based information device includes a read-only small form factor optical disk.

9. The method of claim 1 wherein some or all update information from the data provider 150 is stored using one or more storage means selected from a group consisting of memory caching, disk caching, non-volatile random access memory (NVRAM), magnetoresistive random access memory (MRAM), and a mixed-function disk.

10. The method of claim 1 wherein requesting update information from a data provider 150 comprises sending one or more items selected from a group consisting of the user's search criteria, the geophysical location of the disk-based information device, identifiers for the user of the disk-based information device, identifiers for the application being used, and identifiers for the disk being used.

11. The method of claim 10 wherein information sent to the data provider 150 is used to minimize the amount of update information transferred by the data provider 150.

12. A computer-usable medium for receiving updated information using a portable disk-based information device, comprising:
computer program code for requesting update information from a data provider 150;
computer program code for receiving the update information from the data provider 150;
computer program code for comparing the update information with information provided on the disk; and
computer program code for delivering updated information to a user in response to a user request, reporting new information and replacing outdated information provided on the disk with information received from the data provider 150.

13. The computer-usable medium of claim 10 further comprising:
computer program code for first agreeing to accept charges associated with receiving update information from a data provider 150.

14. The computer-usable medium of claim 12 wherein requesting update information from a data provider 150 comprises sending one or more items selected from a group consisting of the user's search criteria, the geophysical location of the disk-based information device, identifiers for the user of the disk-based information device, identifiers for the application being used, and identifiers for the disk being used.

15. The computer-usable medium of claim 14 wherein information sent to the data provider 150 is used to minimize the amount of update information transferred by the data provider 150.

16. A system for receiving updated information using a portable disk-based information device, comprising:
means for requesting update information from a data provider 150;
means for receiving the update information from the data provider 150;
means for comparing the update information with information provided on the disk; and
means for delivering updated information to a user in response to a user request, reporting new information and replacing outdated information provided on the disk with information received from the data provider 150.

17. The system of claim 16 further comprising:
means for first agreeing to accept charges associated with receiving update information from a data provider 150.

18. A method for receiving updated information using a disk-based information device, comprising:
broadcasting update information from a data provider 150;
receiving the update information from the data provider 150;
comparing the update information with information provided on the disk; and
delivering updated information to a user in response to a user request, reporting new information and replacing outdated information provided on the disk with information received from the data provider 150.
